(19) United States
(12) Patent Application Publication
(10) Pub. No.: US 2017/0368929 A1
(43) Pub. Date: Dec. 28, 2017

(54) HYBRID VEHICLE INCLUDING BATTERY AND FUEL TANK

(71) Applicants: Hyundai Motor Company, Seoul (KR); Kia Motors Corporation, Seoul (KR)

(72) Inventors: Bu Yeol RYU, Hwaseong-si (KR); Ji Hoon Woo, Goyang-si (KR); Joo Yeon Kim, Seoul (KR); Joo Nam Kim, Yongin-si (KR)

(73) Assignees: Hyundai Motor Company, Seoul (KR); Kia Motors Corporation, Seoul (KR)

(21) Appl. No.: 15/629,379

(22) Filed: Jun. 21, 2017

(30) Foreign Application Priority Data
Jun. 22, 2016 (KR) 10-2016-0077736

(51) Int. Cl. B60K 15/067; B60K 1/04; B60K 6/28; B60K 15/063

(52) U.S. Cl. CPC B60K 15/067; B60K 6/28; B60K 1/04; B60K 2015/0638; B60K 2001/0438; B60K 2001/0422; B60Y 2200/92; Y10S 903/907; B60K 2015/0633

(57) ABSTRACT

A hybrid vehicle may include a battery and a fuel tank, wherein the battery is mounted in a space defined under a body floor, on which a double seat is disposed, and the fuel tank is disposed over an upper end portion of a rear-wheel suspension and a rear of a body cross member.

### CROSS-REFERENCE(S) TO RELATED APPLICATIONS

The present application claims priority to Korean Patent Application No. 10-2016-0077736, filed on Jun. 22, 2016, the entire contents of which are incorporated herein by reference.

### BACKGROUND OF THE INVENTION

### Field of the Invention

The present invention relates to a hybrid vehicle including a battery and a fuel tank. More particularly, the present invention relates to a hybrid vehicle including a battery and a fuel tank that is capable of improving marketability with regard to a trunk compartment and the distribution of weight in the trunk compartment

### Description of Related Art

In general, a hybrid vehicle, such as a plug-in hybrid electric vehicle (PHEV) or a hybrid electric vehicle (HEV), is a vehicle including a gasoline engine and an electric motor, wherein the gasoline engine and the electric motor are selectively driven. The electric motor is charged when the gasoline engine is driven under inefficient traveling conditions, thereby improving efficiency of the entire system.

In the state in which power from the engine is not necessary, the hybrid vehicle travels using only the electric motor, whereby the noise and fuel economy of the vehicle are improved. In addition, the amount of harmful exhaust is also reduced.

In recent years, the demand for a hybrid vehicle capable of reducing the amount of harmful exhaust has increased in response to the tightened regulations of exhaust gas and requirements for increased fuel economy.

In the hybrid vehicle, however, a high voltage battery is mounted in an interior trunk compartment. As a result, volume in the trunk compartment is decreased, whereby marketability with regard to the trunk compartment is reduced, and it is difficult to distribute weight in the trunk compartment.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a hybrid vehicle including a battery and a fuel tank, wherein the battery is mounted under a double seat and the fuel tank is disposed at the upper end portion of a rear-wheel suspension to be fixed thereto and supported thereby, therefore improving marketability with regard to a trunk compartment and the distribution of weight in the trunk compartment.

Various aspects of the present invention are directed to providing a hybrid vehicle including a battery and a fuel tank, wherein the battery is mounted in a portion defined under a body floor, on which a double seat is disposed, and the fuel tank is disposed over the upper end portion of a rear-wheel suspension and the rear of a body cross member.

In an exemplary embodiment, the fuel tank may be disposed in a seating area defined at the upper end portion of the rear-wheel suspension and the rear of the body cross member wherein the fuel tank can be supported by the body of the vehicle via a fuel tank band, and the seating area may be recessed upwards, wherein the top surface of the seating area defines the bottom surface of a trunk compartment.

In another exemplary embodiment, the fuel tank may be fastened and fixed to the body cross member.

In still another exemplary embodiment, the fuel tank may be provided with an insulating member disposed at a region in which the fuel tank is fastened to the body cross member, and is in frictional contact with the rear-wheel suspension to absorb vibrations.

In yet another exemplary embodiment, the fuel tank may be fastened to a fuel tank assembly bracket disposed at the rear-wheel suspension, and may be mounted and fixed in the body by the disposition of the rear-wheel suspension.

In still yet another exemplary embodiment, the rear-wheel suspension may be disposed with a pair of stoppers protruding from the upper part of the rear-wheel suspension configured for allowing the upper arms to be mounted therein and preventing the forward movement of the fuel tank.

It is understood that the term “vehicle” or “vehicular” or other similar term as used herein is inclusive of motor vehicles in general including occupant automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above various features and embodiments of the invention are discussed infra.

The apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view schematically depicting the structure in which a battery and a fuel tank are disposed in a hybrid vehicle according to an exemplary embodiment of the present invention;

FIG. 2 is an exploded perspective view depicting the installation of the fuel tank in the hybrid vehicle according to an exemplary embodiment of the present invention;

FIG. 3 is a view depicting the state in which a fuel tank band is coupled in the hybrid vehicle according to an exemplary embodiment of the present invention;

FIG. 4 is a view depicting the fastening of the fuel tank in the hybrid vehicle according to an exemplary embodiment of the present invention;

FIG. 5 is a view depicting an insulating member in the hybrid vehicle according to an exemplary embodiment of the present invention;

FIG. 6 is a view depicting a stopper in the hybrid vehicle according to an exemplary embodiment of the present invention; and

FIG. 7 is a view depicting the fastening of a fuel tank in a hybrid vehicle according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes, will be determined in part by the particular intended application and use environment.

In the figures, reference numbers refer to the same or equivalent parts of the present invention throughout the several figures of the drawing.

### DETAILED DESCRIPTION

Reference will not be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is intended to cover not only the exemplary embodiments, but also various alternatives, modifications, equivalents and other embodiments, which may be included within the spirit and scope of the invention as defined by the appended claims.

In addition, in the description of the present invention, a detailed description of related known technologies and the like will be omitted when it is judged to make the subject of the present invention unclear.

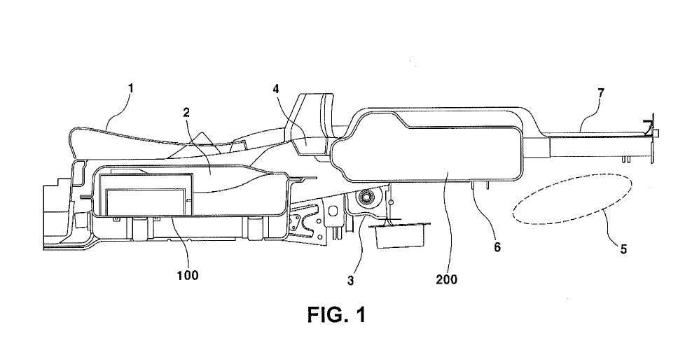

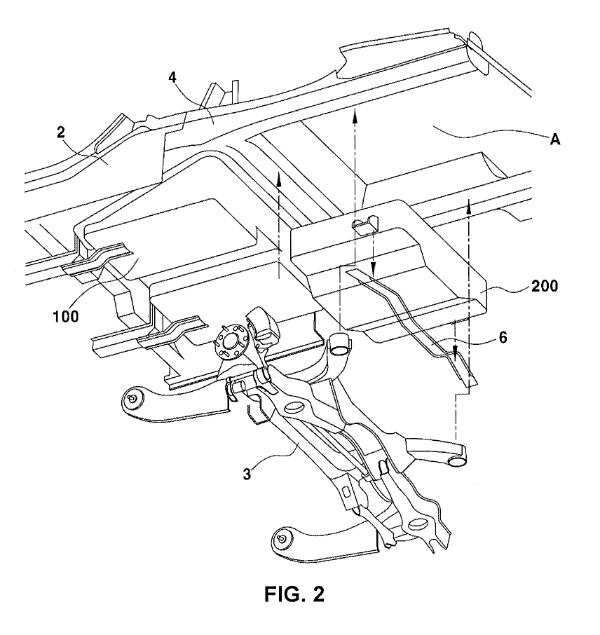

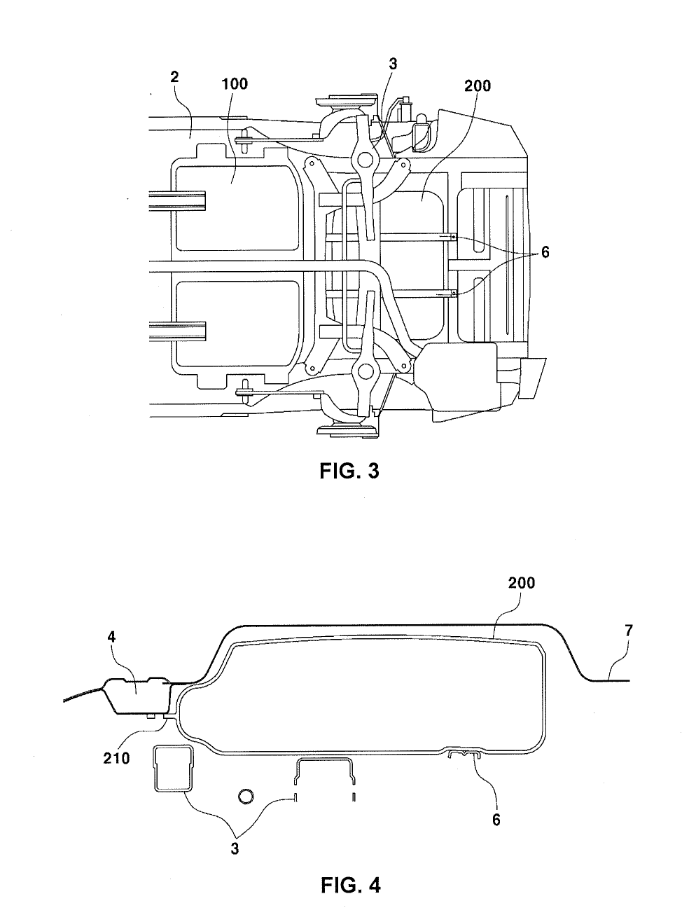

FIG. 1 is a view schematically depicting the structure in which a battery and a fuel tank are disposed in a hybrid vehicle according to an exemplary embodiment of the present invention, FIG. 2 is an exploded perspective view depicting the disposition of the fuel tank in the hybrid vehicle according to the exemplary embodiment of the present invention, and FIG. 3 is a view depicting the state in which a fuel tank band is coupled in the hybrid vehicle according to the exemplary embodiment of the present invention.

In the hybrid vehicle according to the present embodiment, as shown in FIG. 1, a battery 100 is mounted in a space defined under a body floor 2 on which a double seat 1 is disposed, and a fuel tank 200 is disposed over the upper end portion of a rear-wheel suspension 3 and the rear of a body cross member 4.

In a conventional hybrid vehicle, the fuel tank 200 is mounted in the area in which the battery 100 is mounted in the exemplary embodiment, and the battery 100 is mounted in an area defined under a trunk compartment. As a result, the area in the trunk compartment is decreased, whereby marketability with regard to the trunk compartment is reduced, and it is difficult to distribute weight in the trunk compartment.

In the present embodiment, the battery 100 is mounted in the area defined under the body floor 2, on which the double seat 1 is disposed, and the fuel tank 200 is disposed at the upper end portion of the rear-wheel suspension 3 and the rear of the body cross member 4, i.e. between the rear-wheel suspension 3 and a thermal damage prevention muffler 5, improving marketability with regard to the trunk compartment and the distribution of weight in the trunk compartment.

As shown in FIG. 2, the fuel tank 200 is disposed in a seating area A defined at the upper end portion of the rear-wheel suspension 3 and the rear of the body cross member 4, wherein the fuel tank 200 can be supported by the vehicle body via a fuel tank band 6.

The fuel tank band 6 surrounds the external surface of the fuel tank 200 together with the rear-wheel suspension 3 and is fastened to the body to support the fuel tank 200. The fuel tank band 6 includes a steel plate having a predetermined thickness, by which the rigidity of the fuel tank band 6 is increased. In addition, to the present end, ribs may be formed on the fuel tank band 6.

The fuel tank band 6 may extend in the longitudinal direction of the fuel tank 200 to support the fuel tank 200. Alternatively, as shown in FIG. 3, a pair of fuel tank bands 6 may be disposed in the state of being distanced apart from each other in the lateral direction of the fuel tank 200 to support the fuel tank 200.

Although not shown, the seating area A is recessed upward from a base surface 7 of the body wherein the top portion surface of the seating area A defines the bottom surface of the trunk compartment, accordingly a trunk board disposed in the trunk compartment extends.

In addition, the rear end portion of the seating area A, the upper part of which is recessed, may be formed to be lower than the base surface 7 of the body wherein spare tools and tires may be loaded in the trunk compartment.

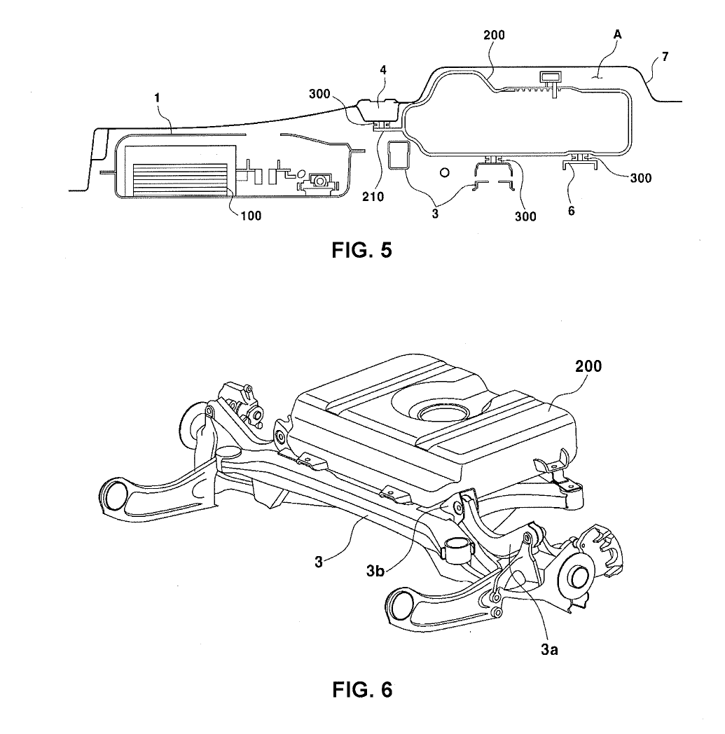

FIG. 4 is a view depicting the fastening of the fuel tank in the hybrid vehicle according to the exemplary embodiment of the present invention, FIG. 5 is a view depicting an insulating member in the hybrid vehicle according to the exemplary embodiment of the present invention, and FIG. 6 is a view depicting a stopper in the hybrid vehicle according to the exemplary embodiment of the present invention.

As shown in FIG. 4, the fuel tank 200 is fastened and fixed to the body cross member 4.

In detail, a forward-protruding fastening part 210 of the fuel tank 200 is positioned at a fastening bracket formed at the body cross member 4 in the state in which the fuel tank 200 is disposed in the seating area A, and then the fuel tank 200 may be fixed to the body cross member 4 using a fastening member.

The rear-wheel suspension 3 and the fuel tank band 6 are disposed at the fuel tank 200, which is disposed in the seating area A to be fixed, and then the rear-wheel suspension, the fuel tank band 6, and the fuel tank 200 are fastened to the body, whereby the fuel tank 200 is securely fixed.

As shown in FIG. 5, an insulating member 300 may be disposed at the region in which the fuel tank 200 is fastened to the body cross member 4 and is in frictional contact with the rear-wheel suspension 3.

The insulating member 300 may include an elastic material, such as rubber. The insulating member 300 may also be disposed at the region in which the fuel tank 200 is in frictional contact with the fuel tank band 6, in addition to the body cross member 4 and the rear-wheel suspension 3, to absorb vibrations and noise from the body cross member 4, the rear-wheel suspension 3, and the fuel tank band 6 during the traveling of the vehicle, improving the durability of the fuel tank 200.

Meanwhile, as shown in FIG. 6, the rear-wheel suspension 3 is provided with a stopper 3b configured to allow an upper arm 3a of the rear-wheel suspension 3 to be mounted thereinto.

Specifically, a pair of stoppers 3b may protrude from the upper part of the rear-wheel suspension 3 not only to allow upper arms 3a to be mounted therein, but also to prevent forward movement of the fuel tank 200.

That is, the stoppers 3b may protrude from the rear-wheel suspension 3 to correspond to the front shape of the fuel tank 200. After the fuel tank 200 is located in the seating area A, therefore, the position of the fuel tank in the lateral direction toward the front of the vehicle may be securely fixed in the state in which the position of the fuel tank 200 is fixed in the longitudinal direction by the rear-wheel suspension 3 and the fuel tank band 6.

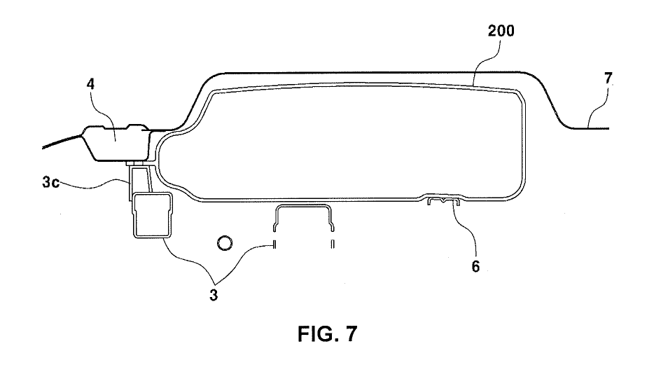

FIG. 7 is a view depicting the fastening of a fuel tank in a hybrid vehicle according to another exemplary embodiment of the present invention.

As shown in FIG. 7, the fuel tank 200 may be fastened to a fuel tank assembly bracket 3c which is disposed at the rear-wheel suspension 3, and may be mounted and fixed in the body, i.e. the seating area A, by the disposition of the rear-wheel suspension 3.

In other words, the fuel tank assembly bracket 3c may be fastened to the fastening part 210 using a fastening member before the fuel tank 200 is located in the seating area A to modularize the fuel tank 200 and the rear-wheel suspension 3, and then the rear-wheel suspension 3 and the fuel tank band 6 may be coupled to the body, whereby the fuel tank 200 may be fixed in the seating area A.

As is apparent from the above description, the present invention has an effect that the battery is mounted under the double seat and the fuel tank is disposed at the upper end portion of the rear-wheel suspension to be fixed thereto and supported thereby, thereby improving marketability with regard to the trunk compartment and the distribution of weight in the trunk compartment.

For convenience in explanation and accurate definition in the appended claims, the terms “upper”, “lower”, “internal”, “outer”, “up”, “down”, “upwards”, “downwards”, “front”, “rear”, “back”, “inside”, “outside”, “inwardly”, “outwardly”, “internal”, “external”, “forwards”, and “backwards”

Are used to described features of the exemplary embodiments with reference to the positions of such features as displayed in the figures,

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the arm to make and utilize various exemplary embodiments of the present invention as well as various alternatives and modifications thereof. It is intended that the scope of the invention be defined by the Claims appended hereto, and their equivalents.

What is claimed is:

1. A hybrid vehicle comprising a battery and a fuel tank, wherein
the battery is mounted in a space defined under a body floor, on which a double seat is disposed, and the fuel tank is disposed over an upper end portion of a rear-wheel suspension and a rear of a body cross member.

2. The hybrid vehicle of claim 1, wherein
the fuel tank is disposed in a seating area defined at the upper end portion of the rear-wheel suspension and a rear of the body cross member, wherein the fuel tank is supported by a body of the vehicle via a fuel tank band, and
the seating area is recessed upwards, wherein a top surface of the seating area defines a bottom surface of a trunk compartment.

3. The hybrid vehicle of claim 1, wherein the fuel tank is fastened and fixed to the body cross member.

4. The hybrid vehicle of claim 3, wherein the fuel tank is provided with an insulating member disposed at a region at which the fuel tank is fastened to the body cross member and is in frictional contact with the rear-wheel suspension to absorb vibration.

5. The hybrid vehicle of claim 1, wherein the fuel tank is fastened to a fuel tank assembly bracket disposed at the rear-wheel suspension, and is mounted and fixed in a body of the vehicle by installation of the rear-wheel suspension.

6. The hybrid vehicle of claim 1, wherein the rear-wheel suspension is provided with a pair of stoppers protruding from an upper part of the rear-wheel suspension for allowing upper arms to be mounted therein and preventing forward movement of the fuel tank.
